(19) United States
(12) Patent Application Publication
(10) Pub. No.: US 2014/0303761 A1
(43) Pub. Date: Oct. 9, 2014

(54) Real Time Digital Signal Processing

(71) Applicant: Red Lion 49 Limited, Begbroke (GB)

(72) Inventor: Paul Alexander Cockram, Abingdon (GB)

(73) Assignee: Red Lion 49 Limited, Begbroke (GB)

(21) Appl. No.: 14/227,717

(22) Filed: Mar. 27, 2014

(30) Foreign Application Priority Data
Apr. 5, 2013 (GB) 1306159.3

(51) Int. Cl. G06F 17/30

(52) U.S. Cl. CPC G06F 17/3074
USPC 700/94

(57) ABSTRACT

An apparatus for performing digital signal processing is shown. The apparatus has memory, a first processing core and a second processing core. The memory stores program instructions, including an operating system and a digital signal processing algorithm for real time processing of a digital signal datastream. The operating system program is executed on the first processing core, and the digital signal processing algorithm is executed on the second processing core. The operating system is configured to operate in nonpreemptive multitasking mode, and the digital signal processing algorithm does not make calls to the operating system so as to remain in execution.

### CROSS REFERENCE TO RELATED APPLICATIONS

This application claims priority from United Kingdom Patent Application No. 13 06 159.3 filed Apr. 5, 2013, the whole contents of which are incorporated herein by reference in their entirety.

### BACKGROUND OF THE INVENTION

1. Field of the Invention

The present invention relates to digital signal processing, particularly but not exclusively the processing of digital signals (possibly digital audio signals) in real time and with low latency.

2. Description of the Related Art

Latency in signal processing systems is generally found when there is a delay between the time at which a signal enters a processing system, and the time at which it exits. It may be caused by various factors, and generally manifests itself in real-time processing systems.

Signal processing has historically taken place in the analog domain, in which electrical circuits designed to effect particular mathematical transformations filter the analog signal. The latency in these systems is in almost all circumstances imperceptible.

More recently, digital signal processing has taken a foothold in which signals represented in a digital format are operated upon by processing hardware implementing digital filters. In order to reduce the latency, or propagation delay of these processing systems, manufacturers tend to employ expensive and specialist dedicated digital signal processors (DSPs) or field programmable gate arrays (FPGAs), both of which are difficult to integrate into products and are difficult to program for.

Alternative digital systems use cheaper, general purpose central processing units, using x86 general purpose instruction sets (such as IA-32 and possibly other extensions such as SSE5) that have associated with them extensive and easy to use programming environments. However, due to typical operating systems for such general purpose processors, latency is both much higher when processing digital signals, and becomes non-deterministic, thereby resulting in unacceptable performance for real-time use.

At present, therefore, there exists a tradeoff in terms of minimizing latency, and minimizing expense and complexity.

### BRIEF SUMMARY OF THE INVENTION

According to a first aspect of the present invention, there is provided apparatus for performing digital signal processing, comprising: memory having program instructions stored therein, including an operating system and a digital signal processing algorithm for real time processing of a digital signal datastream; a first processing core upon which the operating system program is executed; a second processing core upon which the digital signal processing algorithm is executed; wherein: the operating system is configured to operate in a nonpreemptive multitasking mode; and the digital signal processing algorithm is configured to not make calls to the operating system so as to remain in execution.

According to a second aspect of the present invention, there is provided a method of initializing a computer for performing real time digital signal processing of a digital signal datastream, in which the computer has a first processing core, a second processing core and memory, comprising steps of: loading an operating system program into memory and establishing its execution on the first processing core; loading a digital signal processing algorithm into memory and establishing its execution on the second processing core; wherein the operating system is configured to operate in a nonpreemptive multitasking mode; and the digital signal processing algorithm is configured to not make calls to the operating system so as to remain in execution.

According to a third aspect of the present invention, there is provided a non-transitory computer-readable medium having instructions executable by a computer encoded thereon for execution by a computer having a first processing core, a second processing core and memory, said instructions comprising a boot loader program, an operating system program, and a digital signal processing algorithm, wherein: the boot loader program is configured to load the operating system program into memory and establish its execution on the first processing core, the operating system program is configured operate in a nonpreemptive multitasking mode, and to load the digital signal processing algorithm into memory and establish its execution on the second processing core, the digital signal processing algorithm is configured to perform real time processing of a digital signal datastream, and to not make calls to the operating system so as to remain in execution.

### BRIEF DESCRIPTION OF THE DRAWINGS

FIG. 1 shows an environment in which the problem the present invention solves manifests itself;

FIG. 2 shows a signal processing apparatus embodying the present invention;

FIGS. 3A & 3B show the execution of threads by a processing core;

FIG. 4 is a block diagram of the programs making up the computer-readable instructions of the present invention;

FIG. 5 shows steps carried out to initialize a computer having a first processing core and a second processing core for carrying out signal processing;

FIG. 6 is a block diagram showing the sub-routines in the digital signal processing program of the present invention; and

FIG. 7 shows a mixing console incorporating the signal processing apparatus of the present invention.

### DETAILED DESCRIPTION OF EXAMPLE EMBODIMENTS

The following embodiments are described in the context of performing digital signal processing upon audio signals, such as in a mixing console or a digital audio workstation. However, it will be appreciated by those skilled in the art that the principles employed by the present invention have applicability in other situations, such as performing processing upon real time seismic data in an earthquake warning system, or even financial data in an algorithmic trading environment.

Thus, the term “signal” as used herein is generally congruent with the elaboration of the term by the IEEE Transactions on Signal Processing as including, among others, audio, video, speech, image, communication, geophysical, sonar, radar, medical and musical signals.

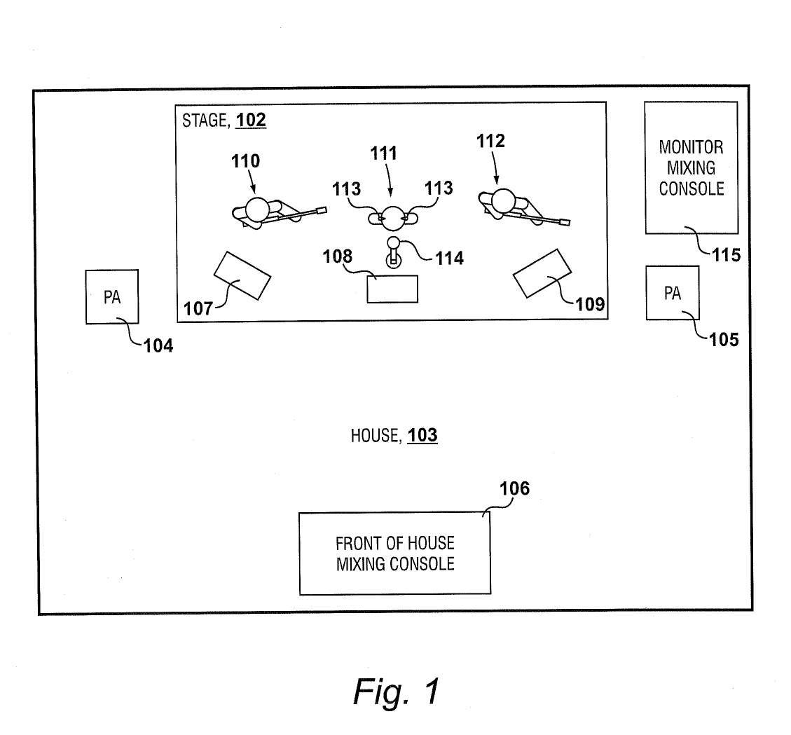

### FIG. 1

A salient example of methods to curb latency imposed by a digital signal processing system may be found in a live music performance, in which an analog signal is received at a digital mixing console from a microphone.

FIG. 1 illustrates a venue 101 in which a three-member band is performing on a stage 102 to an audience in the house 103. A public address system including two loudspeakers 104 and 105 is provided, the mix for which is generated by a front of house mixing console 106. In this example, front of house mixing console 106 is a digital mixing console which imposes a relatively high latency—what may be considered a “low-end” console.

Three onstage monitor loudspeakers 107, 108 and 109 are provided as part of a foldback system for band members 110, 111 and 112 in order for them to hear themselves. Band member 111, the vocalist, also uses in-ear monitors 113 of the known type to monitor his own voice so as to remain in time and in tune, et cetera.

In performance, band member 111 sings into a microphone 114, creating an analog microphone signal. This analog microphone signal must first be digitized, mixed, processed and routed to the correct destination by front of house mixing console 106—all of which steps impose a total latency in the region of tens of milliseconds. This may be acceptable for the front of house mix delivered to the audience, but it would be unacceptable for this degree of latency to be imposed in a cue mix signal for the vocalist using in-ear monitors 113. This is because the vocalist's voice is transmitted through their skull to their eardrum, meaning that the audio provided to their in-ear monitors would arrive noticeably later if delivered by front of house mixing console 106. This would create for bandmember 111 a severe sense of disorientation, which is a major contributor to the fact that front-of-house mixing console 106 would typically be supplemented by a monitor mixing console 115, implemented by specialist hardware, so as to minimize latency. Monitor mixing console 115 in the type of environment illustrated in the Figure is provided solely for a producing one or more cue mixes for the foldback system (monitor loudspeakers 107, 108 and 109, and in-ear monitors 113).

The present invention allows the function of the monitor mixing console 115 to be performed using general purpose processing devices by providing a scheme by which latency in such devices can be minimized whilst rather than resorting specialist hardware. A technical approach is taken to achieve this without resorting to merely circumventing the problem by, for example, using specialist hardware solely dedicated to a specific task.

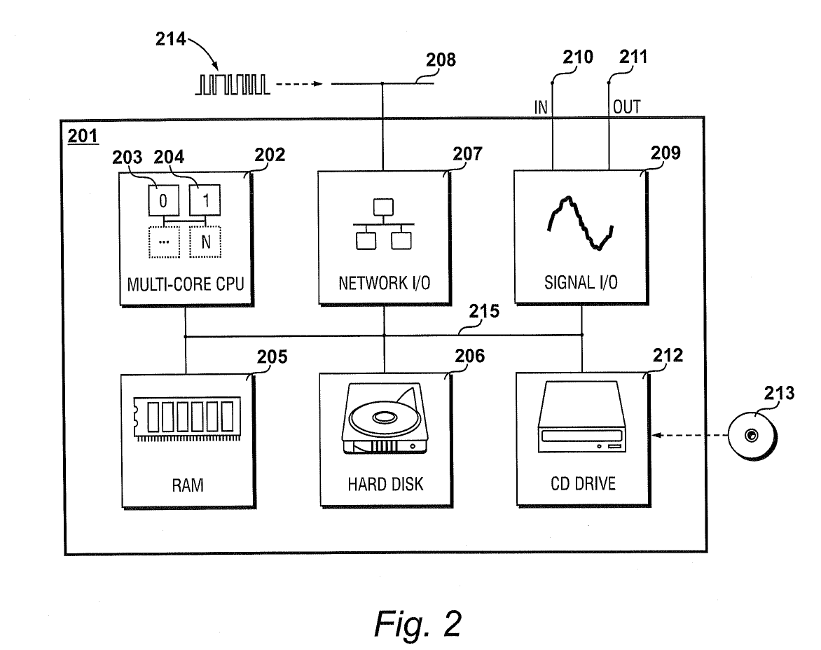

### FIG. 2

A signal processing apparatus 201 suitable for performing digital signal processing is shown in block diagram form in FIG. 2. It will be seen that signal processing apparatus 201 includes substantially the same components as a general purpose personal computer.

Thus, a processor is provided by multi-core central processing unit (CPU) 202 for the execution of program instructions. In a specific embodiment, CPU 202 is a dual-core processor, and thus has a first processing core 203 (core 0) and a second processing core 204 (core 1) present on the same processor die. As will be appreciated by those skilled in the art, quad- and hexa- and octa-core processors are now available, which may all be employed in signal processing apparatus 201. This is shown in the Figure as processing cores being present up to core N. In alternative embodiments, the processor could be provided by two or more discrete CPUs, each being either single-core or multi-core. The present invention may use any combination of processor configurations, simply requiring that there be a first and a second core upon which processes may be executed concurrently.

Memory in signal processing apparatus 201 is provided by the one or more cache provided by CPU 202, and also by random access memory (RAM) 205 and the permanent storage offered by a hard disk drive 206. RAM 205 is provided in this example by eight gigabytes of DDR3 SD-RAM, but as will be appreciated by those skilled in the art the volume and type of memory is not of critical importance and can vary from application to application, and will at the very least need to be compatible with, amongst other things, the CPU(s) present in signal processing apparatus 201. The memory in signal processing apparatus 201 further includes a BIOS or EFI of the known type (not shown) for hardware initialization after power up.

In this embodiment, hard disk drive 206 is a mechanical Serial ATA hard disk drive and has a capacity of one terabyte. Alternatively, the permanent storage could be a solid state drive to provide higher performance. As will be appreciated by those skilled in the art, in alternative embodiments, a number of hard disk drives could be provided and configured as a RAID array to improve data access times and/or data redundancy.

A network interface 207 allows signal processing apparatus 201 to connect to and receive network traffic over a network 208. In this example, network interface 207 network interface is a gigabit-class Ethernet network interface, but in alternative embodiments could be a wireless local area network interface (802.11 family).

An audio signal interface 209 is also provided that facilitates the input and output of audio signals via an input terminal 210 and an output terminal 211.

An optical disk drive is also provided in this example by a CD-ROM drive 212, so as to allow the executable instructions of the said third aspect of the present invention encoded upon a computer-readable medium—CD-ROM 213—to be installed on hard disk drive 206, loaded into RAM 205 and executed by CPU 202. Alternatively, the executable instructions (illustrated at 214) could be transferred from a network location (not shown), possibly located on the Internet, over the network 208 using network interface 207.

Each one of the components in signal processing apparatus 201—namely CPU 202, RAM 205, hard disk drive 206, network interface 207, audio signal interface 209 and CD-ROM drive 212—is connected by a high-speed internal bus 215 of the known type allowing communication between the components.

In use, audio signal interface 209 is predominantly provided so as to allow the provision of a digital signal datastream to CPU 202 for signal processing to take place. In an embodiment, audio signal interface 209 receives an audio signal and derives the digital signal datastream therefrom. In a more specific embodiment, the audio signal interface 209 includes an analog to digital converter and a digital to analog converter, so as to allow for analog to digital conversion to take place upon an analog input signal, and for digital to analog conversion to take place upon a processed signal for output, say, to an amplifier for eventual reproduction.

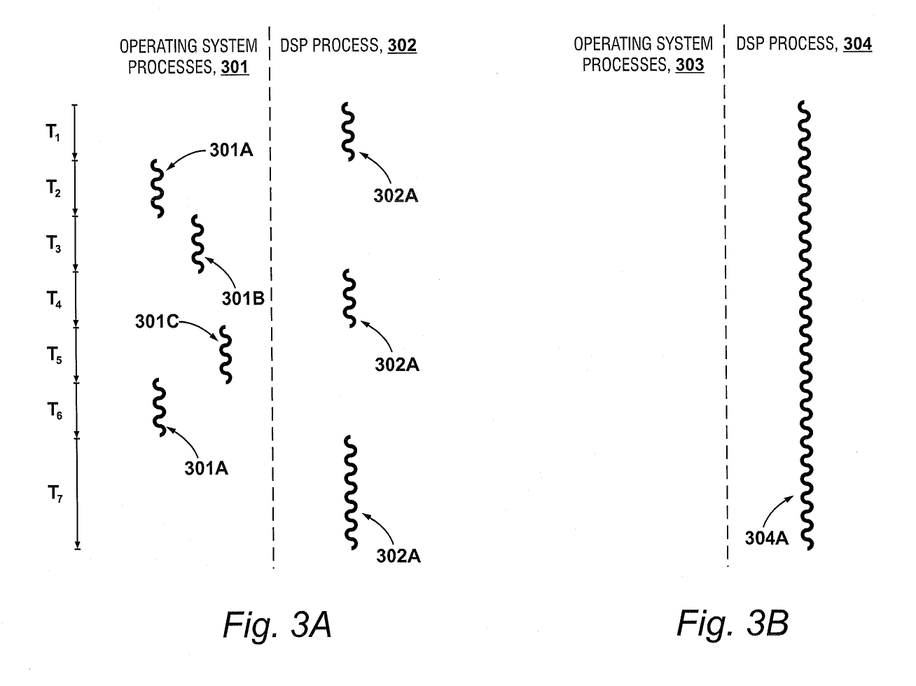

### FIGS. 3A & 3B

As described previously, the present invention provides a scheme by which latency can be minimized in a digital signal processing system that, rather than using specialized hardware, uses general purpose CPU with a simpler-to-develop-for instruction set.

As will be appreciated by those skilled in the art, x86-type processors have associated with them a multitude of different operating systems, such as Microsoft® Windows®, Apple® OSX® and various GNU/Linux® distributions. These tend to be preemptive multitasking operating systems. Moreover, it is a well-documented fact that an application's executables always tend to be given a lower priority than the operating system's own services. A particular example of this is thermal management processes, whose interrupts are given higher priorities than anything else and so the operating system's scheduler will always schedule out an active process in favor of that service.

This can cause problems when trying to run hard real time processes, which is to say those where missing a deadline is considered a failure, even if the result is correct. It is accepted that there will always be a latency in the processing of signals, but this latency must, especially in the context of providing a cue mix to a vocalist, be provided on time, all the time. Thus, even if a system is fast at processing, giving a low average latency, any jitter around the average latency can have undesirable consequences, and can necessitate the provision of buffers to smooth out the jitter.

An example of this situation is shown in FIG. 3A, in which, first, threads of execution of operating system processes 301 and, second, a thread of execution of a digital signal processing process 302 are illustrated. At time T₁, a DSP thread 302A for processing a digital signal datastream is scheduled in, and so the processor core it is running on is dedicated to executing its instructions. However, at time T₂, an OS thread 301A, with a higher priority that the DSP thread 302A, is scheduled in. At time T₃, another OS thread 301B is scheduled in, At time T₄, the DSP thread 302A is again given CPU time, only for, at time T₅, OS thread 301C to be scheduled in, followed at time T₆ by OS thread 301A. Only at time T₇ is DSP thread 302A given CPU time again.

Thus, it can be seen that not only is the DSP thread 302A scheduled in and out, this scheduling is done in a non-deterministic and jittery manner. For low-latency, real time digital signal processing, it is clear that this scheduling process would not be suitable.

FIG. 3B shows, however, the situation that would be more acceptable: one in which operating system processes 303 are never given CPU time, and a digital signal processing process 304, having only one DSP thread 304A, is scheduled in—and, more importantly, is never scheduled out.

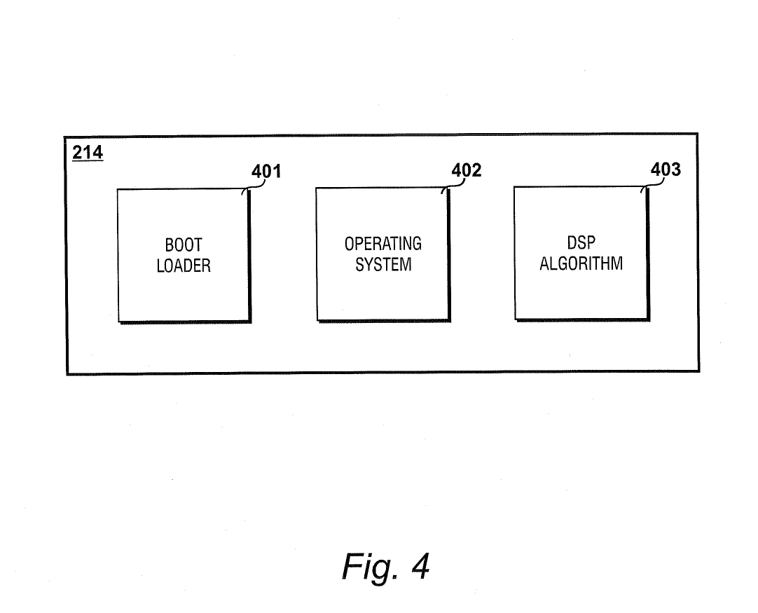

### FIG. 4

The instructions 214 of the present invention, which may in an embodiment be encoded on CD-ROM 213, are shown in block diagram form in FIG. 4.

A boot loader program 401 of the known type is provided, such that a computer has access to instructions as to how to load and initialize itself. A bespoke operating system program 402 is also provided as part of the instructions 214, and in an embodiment is a real time operating system. In a specific embodiment, the operating system is configured to run in a nonpreemptive multitasking mode, in which the operating system never initiates a context switch from a running process to another process.

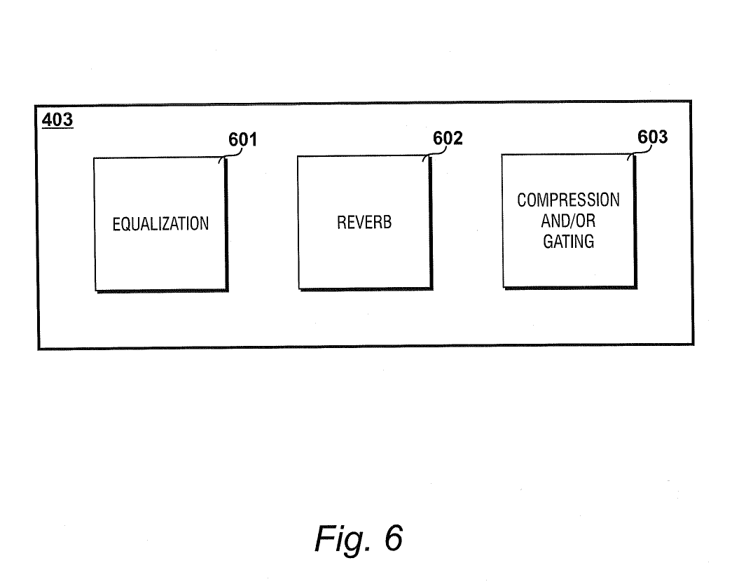

Further, a digital signal processing algorithm 403 is also provided, including various sub-routines for specialized DSP effects, which will be detailed with reference to FIG. 6.

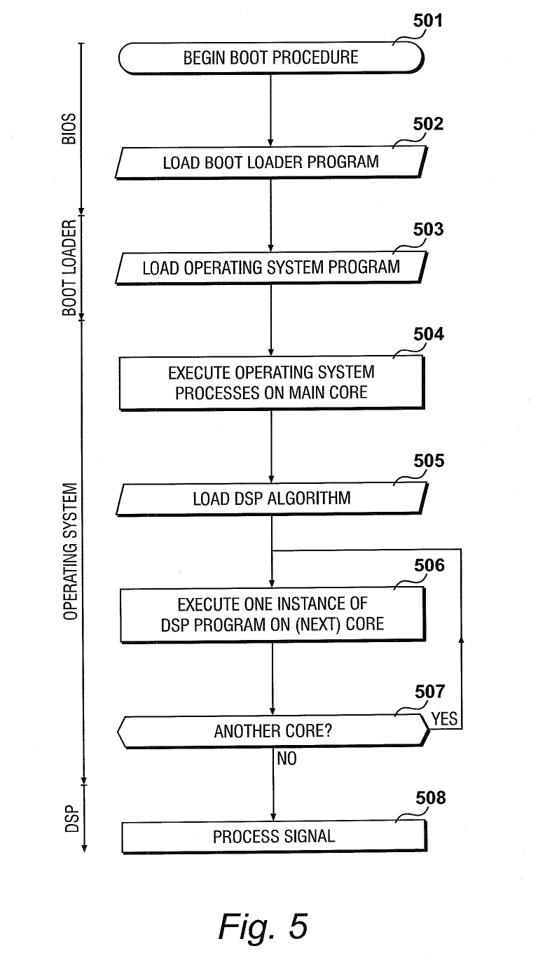

### FIG. 5

Steps carried out during the initialization of signal processing apparatus 201 in which instructions 214 have been installed are detailed in FIG. 5.

At step 501, the boot procedure is started by the BIOS or the EFI and at step 502 the boot loader program 401 is loaded.

Running boot loader program 401 results in the subsequent loading of operating system program 402 into memory. As described previously, signal processing apparatus 201 has a first processing core 203 and a second processing core 204.

Operating system program 402, following loading into memory by boot loader program 401, is configured to execute itself upon the first processing core 203. This involves establishing its services' and processes' threads of execution solely on the first processing core 204, leaving second processing core 204, initially at least, unused.

Following loading and initialization of operating system program 402, at step the digital signal processing algorithm 403 is loaded into memory and execution is begun on second processing core 204. Digital signal processing algorithm 403 is specifically coded so that its process running on a processing core will never make a call to the operating system, and thus will remain in execution. In a specific embodiment, the digital signal processing algorithm 403 is specifically coded so as to only run in one single thread of execution.

As mentioned previously, the operating system program 402 is, in a specific embodiment, configured to operate in a nonpreemptive multitasking mode and so never initiates a context switch. Usually, such multitasking modes exhibit some form of cooperative multitasking, in which case the computational tasks can self-interrupt and voluntarily give control to other tasks. This, combined with the digital signal processing algorithm 403 being specifically configured never to make a call to the operating system, means that the digital signal processing algorithm 403 will never be scheduled out and will therefore always be ready and available to process signals without having to wait for CPU time. The signal processing latency therefore becomes deterministic, and can be reduced to an acceptable level by imposing a processing deadline of around one to two milliseconds—suitable for the provision of a cue mix to a vocalist, as in the example described previously with reference to FIG. 1.

Following step 506, a question is asked at step 507 as to whether another processing core is present. In the specific example of signal processing apparatus 201, this step will be answered in the negative and thus control will proceed to step 508 at which point signal processing can begin.

However, as mentioned previously, the CPU(s) in signal processing apparatus 201 could provide more than two processing cores, and thus step 507 will be answered in the affirmative at least once, leading to the execution of several instances of digital signal processing algorithm 403 on each core not used by operating system program 402.

In use therefore, signals received by the signal processing apparatus 201 via the audio signal interface 209 are transferred over internal bus 205 to CPU 202 as a digital signal datastream, whereupon they are processed by the at least one instance of digital signal processing algorithm 403.

Following processing, the processed signals are then returned via the internal bus 205 to the audio signal interface 209 for output. Processing of the signals by the at least one instance of digital signal processing algorithm 403 is guaranteed, as the threads of execution on the CPU 202 will never be scheduled out.

### FIG. 6

Sub-routines forming part of digital signal processing algorithm 403 are shown in block diagram form in FIG. 6.

An equalization sub-routine 601 is provided, and includes code for application of configurable finite impulse response or infinite impulse response filters et cetera of the known type.

A reverberation sub-routine 602 is also provided, including code to implement reverb effects, possibly using the techniques of convolution reverb or delay networks for example.

A compression and gating sub-routine 603 is provided as well, and allows the application of either or both of these effects using algorithms known to those skilled in the art.

Other sub-routines could also be provided as well, to implement other signal processing effects such as limiting, pitch shifting, or flanging, et cetera.

The advantage provided by the present invention is that, due to its use of a general purpose central processing unit having an instruction set forming part of the x86 family, the sub-routines may be written in high level languages such as C or C++, rather than in assembler or a hardware description language as would be the case with specialized DSP or FPGA hardware.

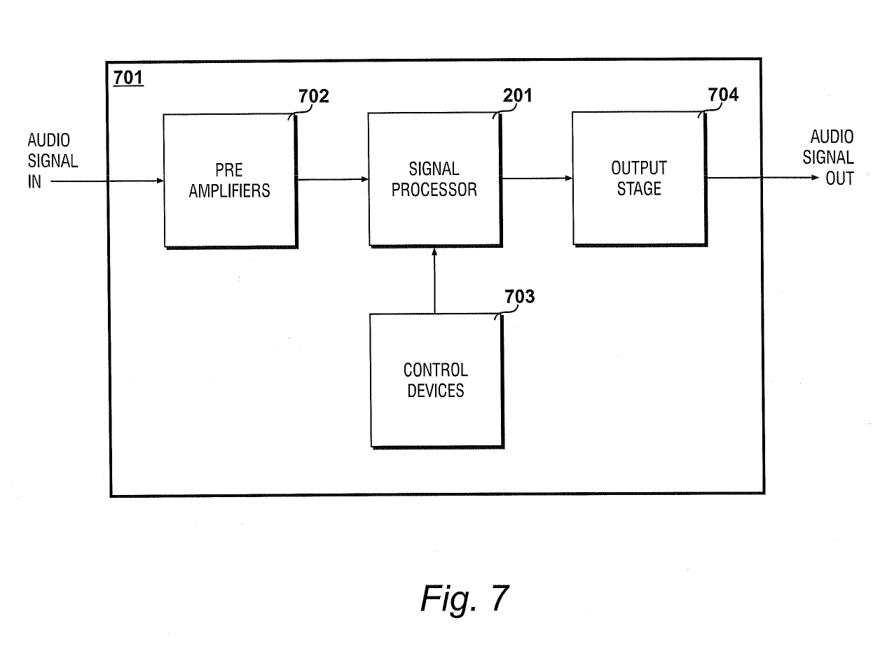

### FIG. 7

In an embodiment of present invention the signal processing apparatus 201 forms part of a mixing console 701, illustrated in FIG. 7.

Thus, in addition to signal processing apparatus 201, an input stage provided by pre-amplifiers 702 of the known type is provided so as to raise the level of an analog input audio signal to a suitable level. A set of control devices 703 is also provided, and is configured to relay instructions provided by an operator to the signal processing apparatus 201 via Ethernet or similar. Such control devices will be known to those skilled in the art, such as controls for configuring various filters et cetera. An output stage 704 is provided to take a processed signal from the signal processor 202 following its digital-to-analog conversion, and provide it to a public address system, a recording system or a foldback system depending upon the application of mixing console 701.

1. Apparatus for performing digital signal processing, comprising:
a memory having program instructions stored therein, including an operating system and a digital signal processing algorithm for real time processing of a digital signal datastream;
a first processing core upon which the operating system program is executed;
a second processing core upon which the digital signal processing algorithm is executed; wherein:
the operating system is configured to operate in a nonpreemptive multitasking mode; and
the digital signal processing algorithm is configured to not make calls to the operating system so as to remain in execution.

2. Apparatus according to claim 1, in which the digital signal processing algorithm is run in a single thread of execution.

3. Apparatus according to claim 1, in which the digital signal datastream is derived from an audio signal.

4. Apparatus according to claim 3, further comprising:
an input stage configured to receive an analog input signal;
an analog-to-digital converter configured to convert said analog input signal into the digital signal datastream for processing;
a digital-to-analog converter configured to generate an analog output signal from the digital signal datastream following processing by the digital signal processing algorithm; and
an output stage for supplying the analog output signal to an amplifier.

5. Apparatus according to claim 3, in which the digital signal processing algorithm is configured to apply a reverberation effect to the audio signal.

6. Apparatus according to claim 3, in which the digital signal processing algorithm configured to apply an equalization effect to the audio signal.

7. Apparatus according to claim 3, in which the digital signal processing algorithm is configured to apply one of a compression effect and a gating effect to the audio signal.

8. Apparatus according claim 4, forming part of a mixing console.

9. Apparatus according to claim 8, in which the analog output signal is supplied to a foldback system.

10. A method of initializing a computer for performing real time digital signal processing of a digital signal datastream, in which the computer has a first processing core, a second processing core and a memory, comprising the steps of:
loading an operating system program into memory and establishing execution thereof on the first processing core;
loading a digital signal processing algorithm into memory and establishing execution thereof on the second processing core;
configuring the operating system to operate in a nonpreemptive multitasking mode; and
configuring the digital signal processing algorithm to not make calls to the operating system so as to remain in execution.

11. The method of claim 10, further comprising the step of establishing the digital signal processing algorithm in a single thread of execution.

12. The method of claim 10, further comprising the step of deriving the digital signal datastream from an audio signal.

13. The method of claim 12, further comprising the step of configuring the digital signal processing algorithm to apply one of:
a reverberation effect,
an equalization effect,
a compression effect, and
a gating effect
to the audio signal.

14. The method of claim 10, further comprising the step of forming the computer as part of a mixing console.

15. A non-transitory computer-readable medium having instructions executable by a computer encoded thereon for execution by a computer having a first processing core, a second processing core and a memory, said instructions comprising a boot loader program, an operating system program, and a digital signal processing algorithm, wherein:
the boot loader program is configured to load the operating system program into the memory and establish execution thereof on the first processing core,
the operating system program is configured to operate in a nonpreemptive multitasking mode, and to load the digital signal processing algorithm into the memory and establish execution thereof on the second processing core,
the digital signal processing algorithm is configured to perform real time processing of a digital signal datastream, and to not make calls to the operating system so as to remain in execution.

16. The non-transitory computer-readable medium of claim 15, in which the operating system program is configured to establish the digital signal processing algorithm in a single thread of execution.

17. The non-transitory computer-readable medium of claim 15, in which the digital signal datastream is derived from an audio signal.

18. The non-transitory computer-readable medium of claim 17 in which the digital signal processing algorithm is configured to apply one of:
a reverberation effect,
an equalization effect,
a compression effect, and
a gating effect
to the audio signal.

19. The non-transitory computer-readable medium of claim 14, in which the computer forms part of a mixing console.
